(19) United States
(12) Patent Application Publication
(10) Pub. No.: US 2013/0016148 A1
(43) Pub. Date: Jan. 17, 2013

(54) INKJET RECORDING APPARATUS

(71) Applicant: Yasunari YOSHIDA, Aichi-ken (JP)

(72) Inventor: Yasunari YOSHIDA, Aichi-ken (JP)

(73) Assignee: BROTHER KOGYO KABUSHIKI KAISHA, Nagoya-shi (JP)

(21) Appl. No.: 13/423,791

(22) Filed: Mar. 19, 2012

(30) Foreign Application Priority Data
Jul. 13, 2011 (JP) 2011-155027

(51) Int. Cl. B41J 29/38

(52) U.S. Cl. 347/14

(57) ABSTRACT

An inkjet recording apparatus is provided. The inkjet recording apparatus includes an ejection unit configured to eject an ink droplet for forming a dot based on image data indicating a dot formation mode for each pixel, and a determination unit configured, for an object pixel in which a dot is to be formed, to perform a surrounding area determination of determining whether another pixel in which a dot is to be formed exists in a surrounding area defined around the object pixel. The ejection unit is configured to perform a dividing ejection which divides an ink droplet for forming a dot of the object pixel into plural ink droplets and ejects the plural ink droplets to plural positions apart from each other, on a condition where it is determined that another pixel in which a dot is to be formed does not exist in the surrounding area.

### CROSS-REFERENCE TO RELATED APPLICATION

This application claims priority from Japanese Patent Application No. 2011-155027, filed on Jul. 13, 2011, the entire subject matter of which is incorporated herein by reference.

### TECHNICAL FIELD

Aspects of the present invention relate to a technique of recording an image by an inkjet method.

### BACKGROUND

There has been known an inkjet recording apparatus which ejects ink droplets to form dots, thereby recording an image. For example, JP 2004-1311A discloses a technique of converting a dot gathering part, in which a plurality of small dots gathers, into a medium dot and replacing a dot gathering part, in which a plurality of medium dots gathers, with a large dot.

In an image which is recorded by the above inkjet recording apparatus, the larger the size of the individual dot, the higher a granularity thereof in an area which is expressed by isolated dots, such as a low density area. On the other hand, for example, in an area which is expressed by a plurality of dots adjacent to each other, such as a high density area, when the size of the individual dot is small, an overlapping of the dots is insufficient, so that banding (streak, unevenness and the like) is likely to be caused due to deviation of a dot formation position and the like.

### SUMMARY

Accordingly, it is an aspect of the present invention to provide a technique for suppressing generation of banding while reducing a granularity of an image which is recorded by an inkjet recording apparatus.

According to an illustrative embodiment of the present invention, there is provided an inkjet recording apparatus including an ejection unit and a determination unit. The ejection unit is configured to eject an ink droplet for forming a dot based on image data indicating a dot formation mode for each pixel. The determination unit is configured, for an object pixel in which a dot is to be formed, to perform a surrounding area determination of determining whether another pixel in which a dot is to be formed exists in a surrounding area which is defined around the object pixel. The ejection unit is configured to perform a dividing ejection which divides an ink droplet for forming a dot of the object pixel into a plurality of ink droplets and ejects the plurality of ink droplets to a plurality of positions apart from each other, on a condition where it is determined that another pixel in which a dot is to be formed does not exist in the surrounding area.

According to this configuration, the dot, which does not have other dot in the surrounding area, is divided and formed at the plurality of positions apart from each other. Therefore, the size of the individual dots to be formed is reduced, so that it is possible to reduce the granularity. Also, since the dot which has other dot in the surrounding area is not divided, it is possible to suppress the generation of banding, which is caused as the size of the dot is reduced.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 is a block diagram showing a configuration of a printer;

FIG. 2 is a flowchart of a head driving control processing;

FIG. 3A shows a surrounding area having 5×5 pixels with an object pixel as a center, FIG. 3B shows a surrounding area having 5 pixels in a main scanning direction with an object pixel as a center, and FIG. 3C shows a surrounding area having two continuous pixels at one side of a main scanning direction with respect to an object pixel;

FIG. 4A shows a state where a droplet for forming a small dot is ejected such that one dot is formed on a sheet, and FIG. 4B shows a state where a droplet for forming a small dot is ejected while being divided such that two dots are formed at an interval on a sheet; and

FIG. 5A shows a low density image which is formed by ejecting a droplet for forming a small dot with one dot on a sheet, and FIG. 5B shows a low density image which is formed by ejecting a droplet for forming a small dot with two divided dots on a sheet.

### DETAILED DESCRIPTION

Hereinafter, an illustrative embodiment of the present invention will be described with reference to the drawings.

### 1. Overall Configuration

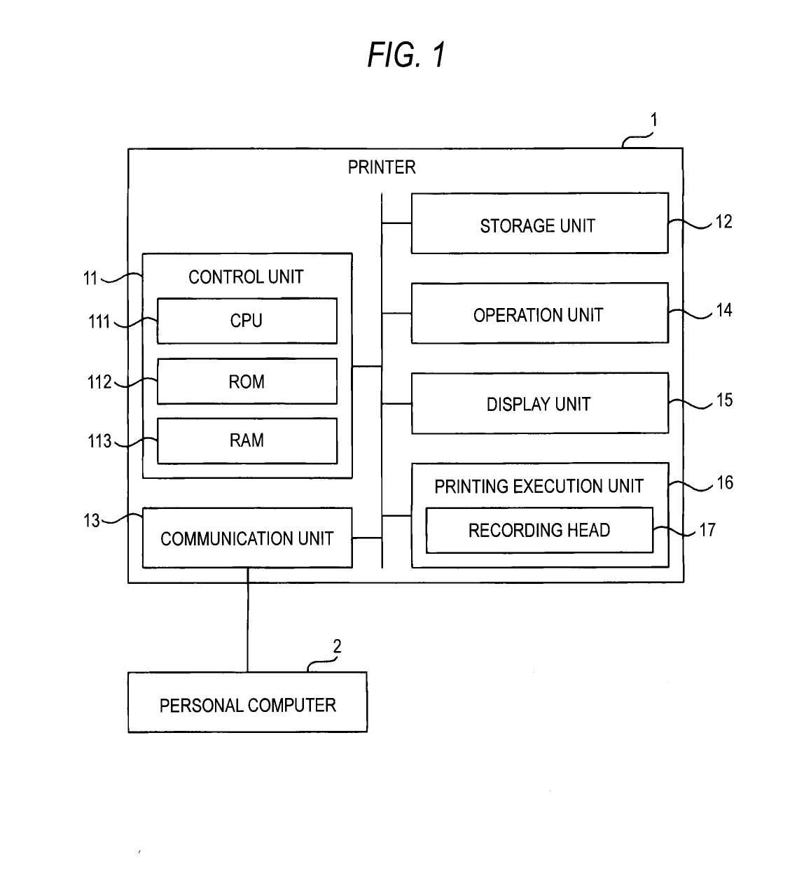

FIG. 1 is a block diagram showing a configuration of a printer 1. The printer 1 is an inkjet recording apparatus and includes a control unit 11, a storage unit 12, a communication unit 13, an operation unit 14, a display unit 15 and a printing execution unit 16.

The control unit 11 collectively controls the respective units of the printer 1 and includes a CPU 111, a ROM 112 and a RAM 113. The storage unit 12 is a non-volatile storage device in which stored data is rewritable, and a flash memory is used as the storage unit, for example. The communication unit 13 is an interface for data communication between the printer and an external apparatus such as personal computer 2. The operation unit 14 is an input apparatus for inputting a command by an external operation of a user and has a variety of operation buttons.

The display unit 15 is an output apparatus for displaying various information as an image which a user can recognize, and a small-sized liquid crystal display is used as the display unit, for example.

The printing execution unit 16 has a recording head 17 which is configured to reciprocate in a direction (main scanning direction) orthogonal to a conveyance direction (sub-scanning direction) of a sheet which is a recording medium. The recording head 17 has a lower surface provided with nozzles for ejecting ink droplets of respective colors of cyan (C), magenta (M), yellow (Y) and black (B). While the recording head 17 reciprocates, the ink droplets are ejected, so that dots are formed on a sheet. The recording head 17 can control an amount of ejection of the ink droplets to form dots of three types having different sizes and can express dot formation modes (four gradations) of four types, i.e., a large dot, a medium dot, a small dot and no dot. The printing execution unit 16 controls driving of the recording head 17 based on image data (image data expressed with four gradations) indicating a dot formation mode of each of CMYK colors for each pixel configuring an image, and causes the recording head 17 to eject the ink droplets of the respective colors for forming dots of respective CMYK colors indicated by the image data.

### 2. Processing

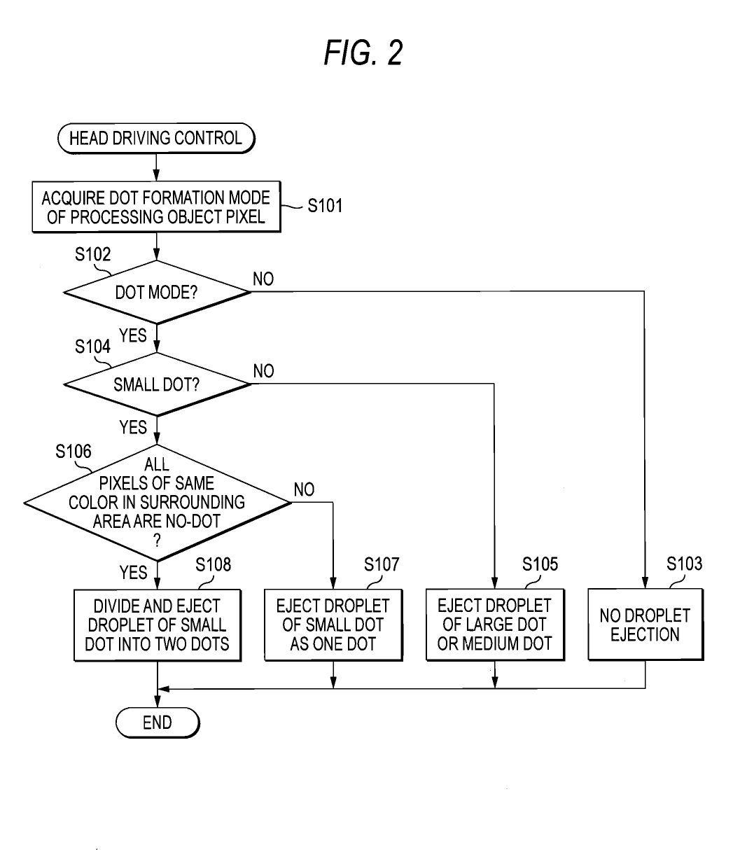

In the below, a head driving control processing which is executed to control the driving of the recording head 17 in the printer 1 is described. FIG. 2 is a flowchart of the head driving control processing which is executed by the control unit 11 (CPU 111) of the printer 1. The head driving control processing is executed for each pixel configuring an image which is indicated by image data. Also, the head driving control processing is executed for each color of CMYK. That is, in the head driving control processing of FIG. 2, one color of one pixel is used as a processing object. The pixel of the processing object (object pixel) is selected in order in the main scanning direction.

When the head driving control processing starts, in S101, the control unit 11 acquires a dot formation mode (large dot, medium dot, small dot or no dot) for a pixel of the processing object based on the image data.

Then, in S102, the control unit 11 determines whether the dot formation mode for the pixel of the processing object is a dot mode (large dot, medium dot or small dot). If it is determined that the dot formation mode is not a dot mode (the dot formation mode is no-dot mode), the process proceeds to S103 and the control unit 11 ends the head driving control processing without ejecting a droplet of a color of the processing object for a pixel of the processing object.

On the other hand, if it is determined in S102 that the dot formation mode for the pixel of the processing object is a dot mode, the process proceeds to S104 and the control unit 11 determines whether the dot formation mode is a small dot mode. If it is determined that the dot formation mode is not a small dot mode (the dot formation mode is a large dot or medium dot mode), the process proceeds to S105 and control unit 11 ejects a droplet of a color of the processing object for forming a large dot or medium dot for a pixel of the processing object and ends the head driving control processing.

On the other hand, if it is determined in S104 that the dot formation mode for a pixel of the processing object is a small dot mode, the process proceeds to S106 and the control unit 11 determines whether all the dot formation modes of a color of the processing object for pixels in a surrounding area based on the pixel of the processing object (pixel for which a small dot is to be formed) are no-dot mode.

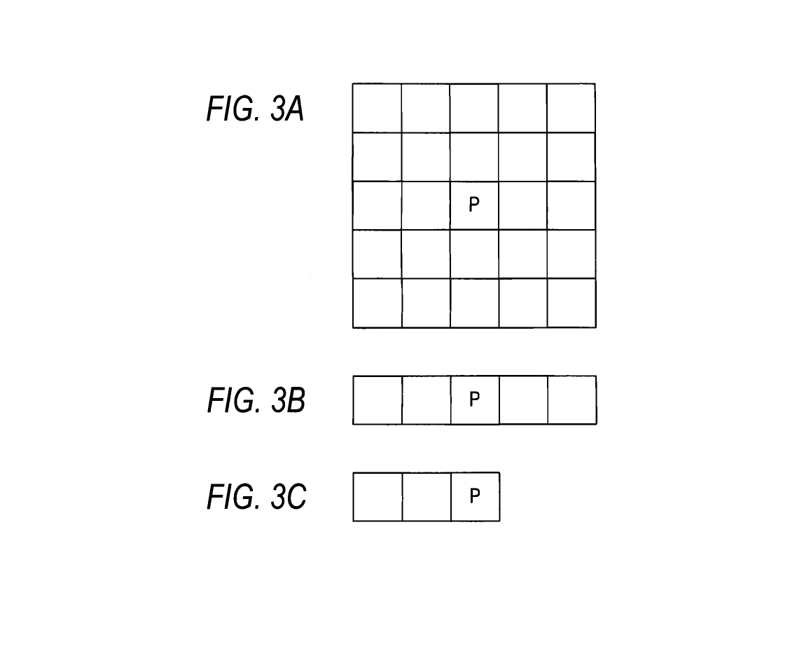

Here, the surrounding area is defined in advance as an area based on an object pixel. For example, in an example shown in FIG. 3A, an area (area except for an object pixel P) having 5×5 pixels with an object pixel P as a center is set as a surrounding area. Also, in an example shown in FIG. 3B, an area (area except for an object pixel P) having 5 pixels in a main scanning direction with an object pixel P as a center is set as a surrounding area. Also, in an example shown in FIG. 3C, an area having two continuous pixels at one side (a side at which a pixel, for which the processing has been completed, is located) in a main scanning direction with respect to an object pixel P is set as a surrounding area.

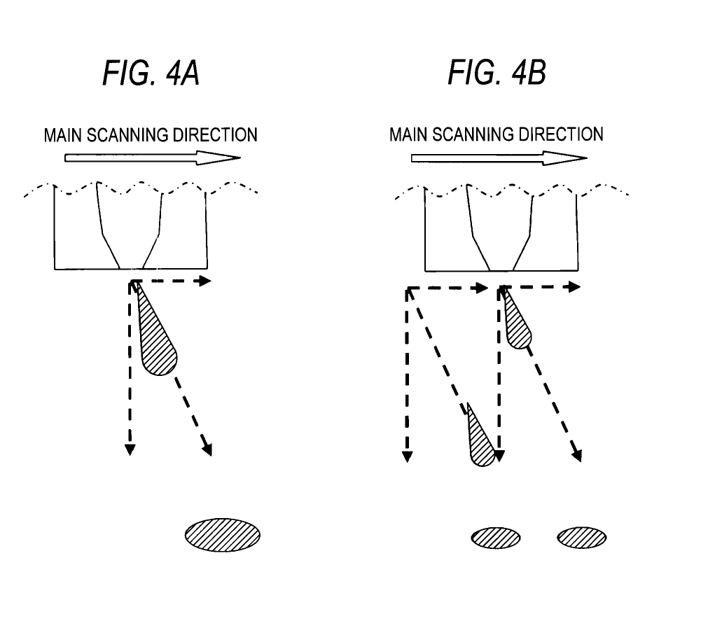

If it is determined in S106 that all the dot formation modes of the color of the processing object for pixels in the surrounding area are not no-dot mode (one or more pixels, for which it is determined that the dot formation mode is a dot mode, are included), the process proceeds to S107, and the control unit 11 ejects a droplet of a color of the processing object for forming a small dot for a pixel of the processing object such that one dot is formed on a sheet, as shown in FIG. 4A, and ends the head driving control processing. On the other hand, if it is determined that all the dot formation modes are no-dot mode, the process proceeds to S108, and the control unit 11 divides and ejects a droplet of a color of the processing object for forming a small dot for a pixel of the processing object such that two dots are formed at an interval on a sheet, as shown in FIG. 4B, and ends the head driving control processing. Here, the method of ejecting the droplet such that one dot is formed on the sheet includes not only a method of ejecting one droplet but also a method of ejecting divided droplets such that dots are formed without an interval on a sheet.

As described above, in the head driving control processing, for a case where the ink droplet for forming a small dot is ejected, if even one other pixel, for which a dot of the same color is to be formed, exists in the surrounding area, the ink droplet for forming a small dot is ejected by the conventional method, i.e., such that one dot is formed on a sheet (FIG. 4A). On the other hand, when such other pixel does not exist, the ink droplet for forming a small dot is divided into two ink droplets, which are then ejected to two positions at which dots are apart from each other (FIG. 4B). Here, the two positions apart from each other are set with a first position which is an ejection position (conventional ejection position) when the ink droplet is ejected such that one dot is formed on a sheet and a second position which is displaced (apart) from the first position in the main scanning direction. In this illustrative embodiment, the second position is displaced and set at a side (a direction along which the recording head 17 is scanned) at which the pixel for which the processing has been completed is located. Also, an interval between the dot which is formed at the first position and the dot which is formed at the second position may be set to be 0 to 40 μm (which is an interval in which dots do not overlap with each other to a size of one dot), for example.

### 3. Effects

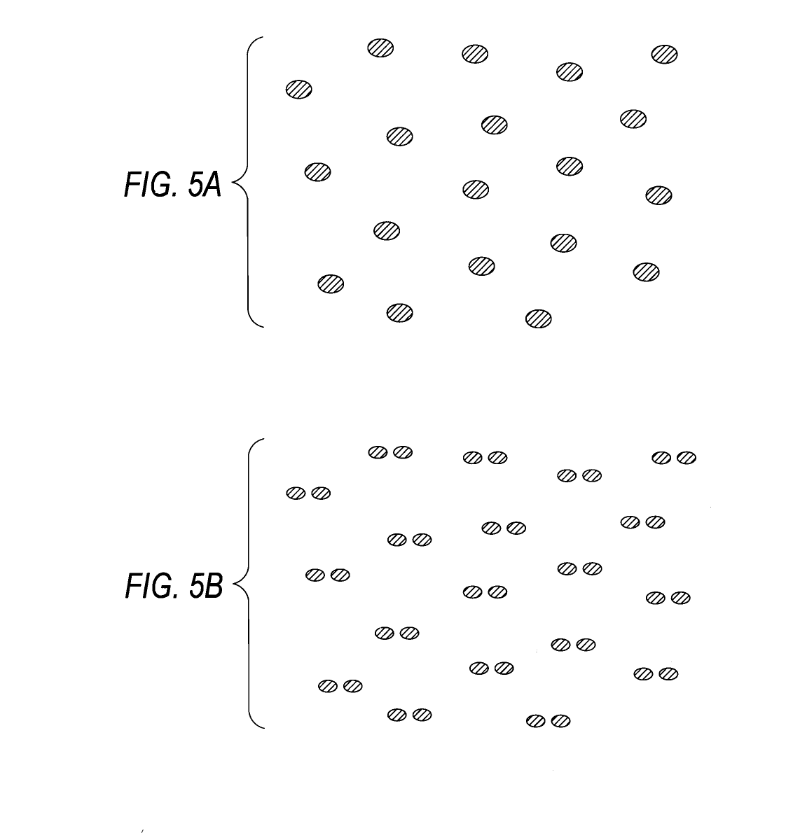

As described above, according to this illustrative embodiment, the small dot, which does not have other dot of the same color in the surrounding area, is divided and formed at the plurality of positions apart from each other. FIG. 5A shows that a droplet for forming a small dot is ejected by the usual (conventional) method, i.e., such that one dot is formed on a sheet, thereby forming a low density image. FIG. 5B shows that a droplet for forming a small dot is divided and ejected such that two dots are formed on a sheet, thereby forming the same low density image. As can be clearly seen from FIGS. 5A and 5B, it is possible to reduce the sizes of the individual dots by dividing the small dot into two dots. Accordingly, it is possible to reduce the granularity in an area which is expressed by isolated dots, such as a low density area. In the meantime, when the size of the dot is reduced, an overlapping of the dots is insufficient, so that the banding is likely to be caused due to deviation of the dot formation position and the like. However, according to this illustrative embodiment, since the dot, which has other dot in the surrounding area, is not divided, it is possible to suppress the generation of banding, which is caused as the size of the dot is reduced in an area which is expressed by a plurality of dots adjacent to each other, such as a high density area.

Additionally, since the pixel, which is adjacent to the object pixel P in the main scanning direction, is included in the surrounding areas shown in FIGS. 3A to 3C exemplified in this illustrative embodiment, it is possible to prevent a dot, which is divided and formed with respect to any one pixel, from overlapping with a dot of the other pixel adjacent to the corresponding pixel in the main scanning direction. Here, one of the dots divided into two is ejected to the second position which is displaced along the main scanning direction to the side at which the pixel, for which the processing has been completed, is located. In the surrounding areas shown in FIGS. 3A to 3C, the pixel (for which the processing has been completed), of the pixels adjacent to the object pixel P at both sides in the main scanning direction, at the side at which at least the second position is located is included. Therefore, it is possible to prevent a dot of the dots divided and formed with respect to any one pixel, which is formed at the second position, from overlapping with a dot of the other pixel (for which the processing has been completed) adjacent to the corresponding pixel at the side at which the second position is located in the main scanning direction. Particularly, since a pixel adjacent to the object pixel P in the sub-scanning direction is included in the surrounding area shown in FIG. 3A, it is possible to suppress the generation of banding, which is caused due to the insufficient overlapping of the dots in the sub-scanning direction.

Furthermore, when dividing and ejecting the ink droplet, the ink droplet is divided into two ink droplets having an equal amount, which are then ejected. Therefore, it is possible to improve a quality of an image which is formed by the divided dots. Also, since the small dot, which has the minimum dot size, is further divided, it is possible to form an image in which the granularity is not noticeable.

In addition, since it is determined whether the other dot exists in the surrounding area on a color-by-color basis, it is possible to prevent the dot from overlapping with the other dot of the same color, which is caused due to the division of the dot. Also, compared to a configuration in which it is determined whether the other dot exists in the surrounding area irrespective of the color, it is possible to increase the number of dots to be divided, thereby reducing the granularity.

### 4. Other Illustrative Embodiments

While the present invention has been shown and described with reference to certain illustrative embodiments thereof, it will be understood by those skilled in the art that various changes in form and details may be made therein without departing from the spirit and scope of the invention as defined by the appended claims.

(1) In the above illustrative embodiment, it is determined whether the other dot exists in the surrounding area on a color-by-color basis. Instead of this configuration, the determination may be made irrespective of the color. In this case, it is possible to prevent the bleeding (color mixture due to ink bleeding), which is caused as a dot overlaps with other color dot of other pixel due to the division of the dot).

(2) In the above illustrative embodiment, when dividing and ejecting the ink droplet, the ink droplets are ejected to the first position which is an ejection position when the ink droplet is ejected to one position and to the second position which is displaced along the main scanning direction from the first position to the side at which the pixel, for which the processing has been completed, is located. However, the present invention is not limited thereto. For example, the second position may be set as a position which is displaced along the main scanning direction from the first position to a side at which the pixel, for which the processing has not been completed yet, is located. In this case, the surrounding area shown in FIG. 3C is preferably reversed right and left. Also, it may be possible to set the first position and the second position at both sides in the main scanning direction with the ejection position, which is an ejection position when the ink droplet is ejected to one position, being interposed therebetween.

(3) In the above illustrative embodiment, when dividing and ejecting the ink droplet, the ink droplet is divided into two ink droplets having an equal amount, which are then ejected. Instead of this, the ink droplet may be divided into two ink droplets with different amounts, which are then ejected. Also, the ink droplet may be divided into three or more ink droplets, which are then ejected.

(4) In the above illustrative embodiment, the printer 1 which can express four gradations has been exemplified. However, the present invention is not limited thereto. For example, a printer which can express two gradations, three gradations or five or more gradations may be used.

What is claimed is:

1. An inkjet recording apparatus comprising:
an ejection unit configured to eject an ink droplet for forming a dot based on image data indicating a dot formation mode for each pixel; and
a determination unit configured, for an object pixel in which a dot is to be formed, to perform a surrounding area determination of determining whether another pixel in which a dot is to be formed exists in a surrounding area, the surrounding area being defined around the object pixel,
wherein the ejection unit is configured to perform a dividing ejection which divides an ink droplet for forming a dot of the object pixel into a plurality of ink droplets and ejects the plurality of ink droplets to a plurality of positions apart from each other, on a condition where it is determined that another pixel in which a dot is to be formed does not exist in the surrounding area.

2. The inkjet recording apparatus according to claim 1,
wherein the ejection unit is configured to set each pixel in the image data as an object pixel in order along a main scanning direction and eject an ink droplet for forming a dot for each object pixel, and
wherein the surrounding area includes a pixel adjacent to the object pixel in the main scanning direction.

3. The inkjet recording apparatus according to claim 2,
wherein the plurality of positions apart from each other include a first position which is an ejection position when an ink droplet is ejected to one position without performing the dividing ejection and a second position which is displaced from the first position in the main scanning direction, and
wherein the surrounding area includes one of two pixels adjacent to the object pixel in the main scanning direction, at a side where the second position is located with respect to the first position.

4. The inkjet recording apparatus according to claim 2,
wherein the surrounding area includes a pixel adjacent to the object pixel in a sub-scanning direction orthogonal to the main scanning direction.

5. The inkjet recording apparatus according to claim 1,
wherein when performing the dividing ejection, the ejection unit is configured to divide an ink droplet for forming a dot of the object pixel into a plurality ink droplets having an equal amount and eject the plurality of ink droplets.

6. The inkjet recording apparatus according to claim 1,
wherein the dot formation mode includes a plurality of dot sizes to be formed, and
wherein the ejection unit is configured to perform the dividing ejection, on a condition where the object pixel is a pixel for which a dot having a minimum size is to be formed and it is determined that another pixel in which a dot is to be formed does not exist in the surrounding area.

7. The inkjet recording apparatus according to claim 1,
wherein the ejection unit is configured to eject ink droplets of a plurality of colors for forming dots of respective colors for each pixel based on the image data indicating formation modes for dots of the colors for the pixel, and
wherein the determination unit is configured to perform the surrounding determination on a color-by-color basis.
